(19) United States
(12) Patent Application Publication
(10) Pub. No.: US 2011/0177844 A1
(43) Pub. Date: Jul. 21, 2011

(54) Cellular Mobile Radiotelephone Tower Wind Turbine

(76) Inventor: Albert Frank Lowas, III, Springfield, OH (US)

(21) Appl. No.: 13/008,905

(22) Filed: Jan. 19, 2011

(51) Int. Cl. H04W 52/00; E04H 12/00; E04H 12/34

(52) U.S. Cl. 455/562.1; 52/655.1; 52/40

(57) ABSTRACT

The Cellular Mobile Radiotelephone Tower Wind Turbine (CMRTTWT) specifically is an innovative method of harvesting available wind power around CMRT towers. The CMRTTWT addresses the base station power needs of the Cellular Mobile Radiotelephone (CMRT or Cell Phone) industry, providing clean on-site power generation for reduced environmental impact and for improved availability during disasters (natural or man-made). This invention extends the design of the CMRT tower to include a wind turbine and the associated structural and electrical modifications to accommodate that wind turbine. This wind turbine is designed to provide approximately the daily power demands for the CMRT tower system; thus the turbine would be small enough to be mounted on the tower without interfering with the operations of the antennas. By using the turbine as a constant power source, clean electricity is directly harvested from suitable velocity winds at the higher altitudes of the tower. Once the invention is installed, the electricity required from the power grid is reduced significantly. By designing the system to vary the number of network connections based upon the power available from the turbine, constant operation of at least some capacity is possible even without power from the electrical grid; this is a tremendous advantage for maintaining communication capability during and immediately following disasters (both natural and man-made). The invention creates a low-cost way to harness readily available wind power to generate much needed electrical power for the CMRT industry.

The Cellular Mobile Radiotelephone Tower Wind Turbine (CMRTTWT) harvests available wind power surrounding CMRT towers and uses it to specifically addresses the base station power needs of the Cellular Mobile Radiotelephone (CMRT or Cell Phone) industry; thus providing clean on-site power generation for reduced environmental impact and for improved availability during disasters (natural or man-made).

This invention is possible by reconsidering the joint optimization of the elements of tower, wind turbine, and network availability. The intent of this new solution is to harvest available wind power from the higher portions of the CMRT tower. This invention extends the design of the CMRT tower to include extra structural capacity, height, or both. The invention adds a wind turbine to the tower. This wind turbine is designed to provide approximately the daily power demands for the CMRT station; thus the turbine would be small enough to be mounted on the tower without interfering with the operations of the antennas. By using the turbine as a constant power source, the electricity required from the power grid is reduced significantly. By designing the system to vary the number of network connections based upon the power available from the turbine, constant operation of at least some capacity is possible even without power from the electrical grid; this is a tremendous advantage for maintaining communication capability during and immediately following disasters (both natural and man-made). The CMRTTWT creates this new optimum CMRT tower design.

### OVERVIEW OF CLAIMS

The CMRTTWT consists of three claims which together greatly improve the transmission/receiving tower infrastructure critical to the CMRT industry; specifically in the areas of economic viability, flexibility, survivability, and environmental compatibility.
1. The first claim is the mounting of a wind turbine on a CMRT Tower, specifically sized to provide local power generation for that CMRT Station without interfering with the operations of that CMRT Station.
2. The second claim is the preferred method of mounting a windmill on a CMRT tower, which is on the top of the tower.
3. The third claim involves an application of distributed power generation in which the CMRT tower's transmission/reception services are regulated to match the power available by the wind turbine.

### BACKGROUND

### Prior Art

This invention relates to a series of prior arts. The uniqueness of this invention is its combination of elements of these prior arts in a tailored manner to harvest available wind power to meet the specific power needs of the CMRT industry in a way that enhances environmental quality. These prior arts consist of the radio transmission tower, the CMRT station, the wind turbine, the wind turbine tower, and the management of distributed power.

The prior art of radio transmission towers is well-known. The traditional radio tower consists of a lattice structure which is nominally 30 to 300 feet tall. These towers may be straight, tapered, or doubly tapered, depending upon the site conditions and the means used to optimize the design for the site conditions. This lattice structure is typically supported with tension cables known as guy wires. This prior art radio tower is frequently used for CMRT stations.

A novel growth of the radio transmission tower is the modular or tubular tower. This type of tower takes the shape of a cylinder, a stack of cylinders of decreasing size, a compound contour tapered cylinder, or a straight tapered cylinder. The improved structural rigidity of this cylinder or tapered cylinder typically eliminates the need for the guy wires which are commonly used in the lattice type of design. The system is more suited to locations in which limited geographic space available for the CMRT station.

In the current art of CMRT station design, the radio transmission towers are optimized in the same ways that they have been optimized for 60 years. The radio transmission tower is built to an optimal antenna height for the range desired for the transmissions (or receipt) of signals. The CMRT station uses an optimal height tower to mount antennas for its intended range. The tower is structurally optimized for the number of transmission/receiving antennas intended to cover that range. The station may include a backup generator of the optimal size to provide all of the required electricity to the transmission/receiving antennas.

In the current art, very similar tower designs are frequently used for the mounting of wind turbines. Because the wind nearest to the ground is turbulent and generally low velocity, a tower is typically used to hold the wind turbine at heights at which the air has a higher velocity and lower turbulence. The computation of the turbine height depends both upon cost and upon the boundary layer. Depending upon the geography, the lowest portions of the turning blades should normally be 25 feet above ground level, but for higher efficiency the blades may be mounted so that their tips swing nearly 100 feet above ground level. Generally these increased efficiency mounting heights are only used for large turbine blades generating at least a Megawatt of power. Guyed lattice towers are often used for smaller turbines due to cost, but the need to prevent the blades from striking the guy wires creates a limit on the size of the turbine blades. Structures without guys allow designers to use larger blades such as the Megawatt class designs. A variation uses a turbine that rotates about its vertical axis to prevent the possibility of the blades striking any guy wires or surrounding structures.

The current art of distributed power generation includes numerous concepts to generate power at the point where it is used. These methods generally include small wind power generation units, solar power units, and combined heat and power units. This distributed power generation seeks to reduce the environmental impact of large centralized power generating plants. It reduces environmental impact by reducing transmission losses and by using sources of power that utilize less fossil fuel. To accommodate variations in power usage and availability, the distributed power generation method either shares power with a larger grid or includes an energy storage method.

No current art uses these technologies in combination; each is individually optimized. The wind power available at the higher portions of the CMRT tower are not currently harvested to provide electrical power. It will be seen that this creates a sub-optimum solution to the overall system. The inefficiencies of this separate optimization are apparent through a summary of the difference between current use wind turbine power systems and current use CMRT station power systems.

Current art wind turbine designs seek to maximize the power generation within the constraints of cost, airflow characteristics, and geography at a given site. If this wind turbine is installed as part of a wind farm, it is typically extremely large in size, intended to generate Megawatts of power, and incurs the cost of power losses through transmission and transformers. Current art uses of wind power in distributed power generation methods involve the (often) prohibitive costs of tower construction and energy storage or power grid connections; this is because their goal is to completely accommodate the power needs of a localized demand. The prevailing challenge with the use of wind turbines is the variation in wind speed; this constraint currently requires both a secondary supply during shortages and a means to offload excess power when local supply exceeds demand.

The current art of power supplies for CMRT stations is limited to two established technologies and two emerging technologies. The established technology which is most commonly employed by current CMRT systems is the use of transformers to condition power from national or local electrical grids (herein referred to as power grids). Additionally, some CMRT stations use on-site engine-driven generators. A few CMRT stations are powered by large fuel cells. Solar-powered CMRT stations are being deployed; however, these cost two to three times as much as a traditional CMRT station. In the current art, the on-site power generation is designed to provide the full power supply either continuously or for short periods; the former used for remote locations and the latter used as a backup to the power grid.

The shortfalls and inefficiencies of the current art are readily apparent. CMRT stations powered by ground-based reciprocating engine generators incur the logistical cost of providing fuel to that generator; this can only be offset by using the generator as a backup system which makes the generator a sunk cost without creating useful daily service. Solar powered CMRT systems require locations with consistent long periods of sunlight. New fuel cells also need regular refueling, and are an added expense when not in operation. None of these current art power systems (or power combinations) provides a single perfect solution for all CMRT sites.

### BRIEF DESCRIPTION OF FIGURES

The CMRTTWT is a modification of current CMRT station designs. The figures accompanying this text further clarify that modification.

FIG. 1.1 shows a pre-modification CMRT station, highlighting key features which impact and are improved by the CMRTTWT design.

FIG. 1.2 shows a modified CMRT station in the preferred embodiment of the invention.

FIG. 2 shows a functional block diagram of the primary electrical connections of the invention.

FIG. 3.1 shows a pre-modification CMRT station, highlighting the design factors which impact the installation of a CMRTTWT.

FIG. 3.2 shows a detail of the mounting of a horizontal axis wind turbine on top of a CMRT tower, which is the preferred embodiment of the invention.

FIG. 4 shows a detailed functional block diagram of the proportional transceiver/amplifier availability system, which is part of the preferred embodiment of the invention as a means to expand the utility of the CMRTTWT during periods when the power grid is not available.

### DISCLOSURE OF INVENTION, USE OF A WIND TURBINE IN CONJUNCTION WITH A CMRT STATION TO PROVIDE POWER FOR THAT CMRT STATION

The invention concerns the use of a wind turbine in conjunction with a CMRT station. This invention harvests the wind power which is readily available around CMRT towers. This invention directly connects the electricity generated from a wind turbine to the electronics of a CMRT station, providing power in a specifically conditioned and regulated way as required for the CMRT station. This general functional description provides the foundation for the preferred embodiment of this invention, which is described in the claims of this document.

For the ease of understanding the invention, it is instructive to first understand the design of the CMRT station and the power used by that station. CMRT stations transmit and receive radio signals between handheld CMRT devices and the regional or national telephone or internet systems. The power for these CMRT Station transceivers and their associated amplifiers typically must be 24 Volt Direct Current (VDC) or 48 VDC source, with most of the power drawn by the radio frequency amplifier. Naturally, substantially sized transformers are required to convert common electrical current from the power grid (Alternating Current) to theses voltages.

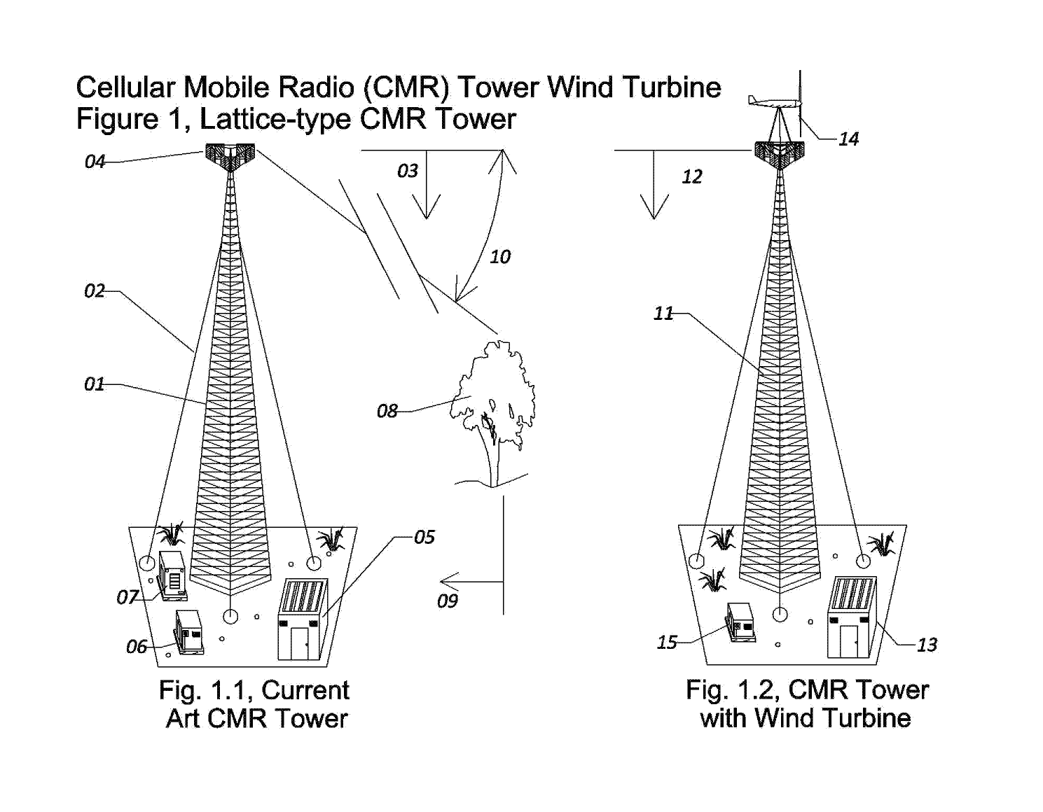

CMRT stations use the prior art of radio transmission towers. Referencing FIG. 1.1, prior art CMRT stations consist of a radio transmission tower (1) with guy wires (2) or a suitable tubular or other tower design without guy wires; this tower is of some desired height (3) to mount CMRT antennas (4). The site also consists of a base transceiver station (5), a power transformer (6), and related support equipment. Frequently, a backup power generator (7) is part of this support equipment. The tower's height (3) is designed to place the antennas (4) at a desired height to provide a line of sight over obstacles or terrain (8) at some specified distance (9). Each antenna is designed for a specific angular field of operation (10).

This invention concerns the direct connection of a wind turbine to the transceiver electronics to provide the specific voltage needed for the transceiver electronics. This unique arrangement minimizes or eliminates the need for expensive power conversion. Those informed in the arts of electricity distribution and electronics will recognize that the addition of switches and power conditioners is typically implied for any highly robust direct electrical connection. Likewise in this newly invented system the direct connection would typically require a power conditioner to moderate the natural variations in power output which are common for wind turbines; the informed reader will realize that there are many technologies available to perform this power regulation. Those versed in the related arts will realize the ready availability of wind turbines which directly generate 24VDC or 48VDC power, and the ready availability of power conditioners for that class of wind turbine.

Comparing FIG. 1.1 and FIG. 1.2, the invention retains the general design of a CMRT tower (11) and places the antennas at the same required height as a current art CMRT tower (12). Like a current art CMRT tower, the invention includes a base station (13). However, the invention adds a wind turbine (14) at a location at which it receives the required flow of air, which is typically at the top of the tower. This invention enables a smaller power transformer (15) and the elimination of the backup power unit.

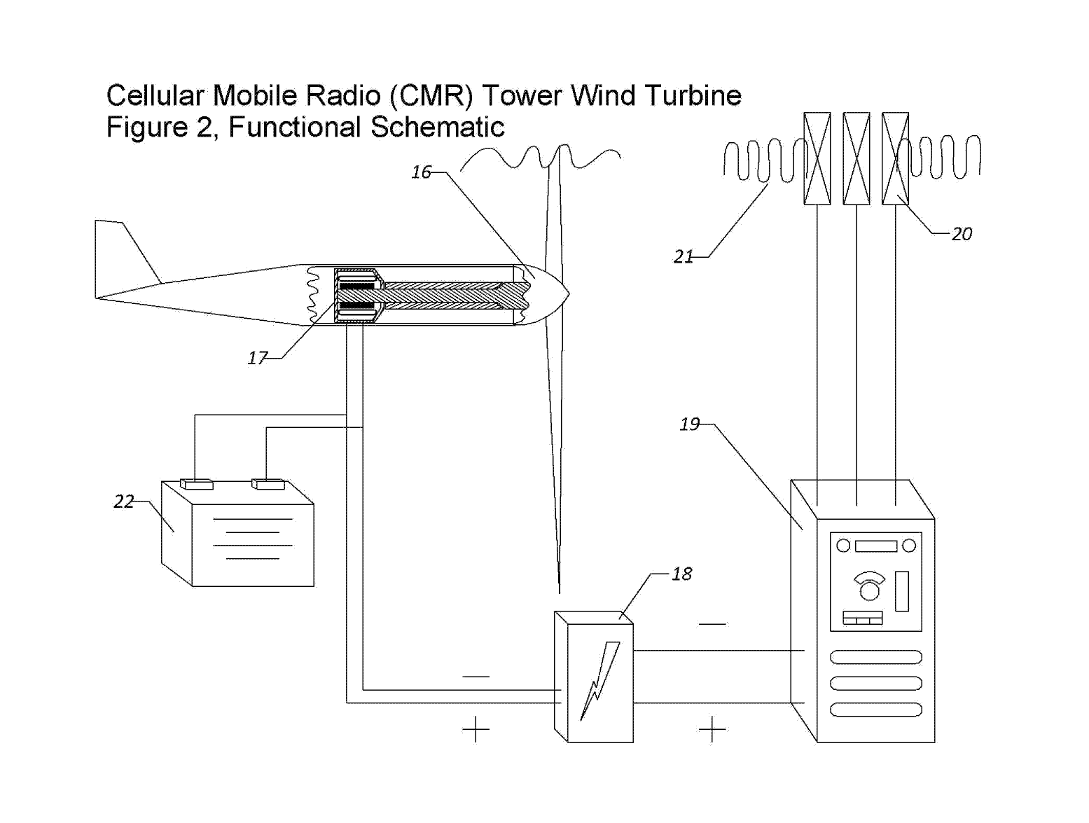

The general arrangement of this invention is functionally shown in FIG. 2. A wind turbine (16) is used to drive a generator (17). This may be a horizontal axis wind turbine (as shown in cutaway), a vertical axis wind turbine, or any other type of wind turbine. The generator (17) feeds power to the conditioner (18) then on to the CMRT Base Station electronics (19). The CMRT Base Station electronics send appropriate signals to the antennas (20) which emit radio waves (21) for hand-held CMRTs. Naturally, as per current art for CMRT stations, the process works in both directions, and radio waves (21) may be received by the antennas (20) and processed by the CMRT Base Station electronics (19). A DC battery bank (22) may be used for power storage, such as for key computer functions if the entire system needs to shut down temporarily.

This invention uniquely connects a commonly available wind turbine power supply to commonly available CMRT station transceiver electronics. This arrangement is specifically for the purpose of harvesting available wind power around the CMRT tower to provide efficient locally produced power to the CMRT station. Those informed in the current art will realize that the current art neither co-locates the windmill with the CMRT station nor directly connects the windmill electrical power with the CMRT station electronics. Those individuals familiar with the current art will realize that this configuration differs (for instance) from simply mounting a CMRT transceiver antenna on a convenient high power Megawatt-class wind turbine.

The informed reader will realize that the class of turbine required for direct power generation for a CMRT station is between 2 kilowatts (kW) and 50 kW. The size may be larger or smaller and still be within the intent of this invention, noting that the amount of power required is dependent upon the design of the CMRT station. The exact size of the turbine will vary due to site unique conditions while still serving primarily as a power source for the CMRT station. This class of turbine provides useful size and weight characteristics for overall system optimization as will be referenced in the claims of this invention. The reader familiar with the art of small wind turbines will note the industry shift toward performance standardization and certification of this class of turbine, which is a key factor in improving the viability of these systems as power supplies for CMRT stations.

The above general description of the invention identifies the functional motivation for harvesting power at a CMRT station. The claims of this document further specify the mounting of the wind turbine on the CMRT tower and its practical arrangement to enable continuous operation of the CMRT tower. The preferred embodiment is specified in these claims, as are the naturally apparent variations which exist to incorporate the wind turbine into a CMRT station. The first and second claims concern the location and configuration of that wind turbine, while the third claim concerns the optimal use of the power available from this wind turbine.

Specification, First Claim, Mounting of a Wind Turbine on a CMRT Tower to Provide Power for that CMRT Station:

The first claim concerns the mounting of a wind turbine on a CMRT Tower to provide power for the CMRT station. This claim specifically uses the structure of the CMRT Tower to mount the wind turbine in a low cost, high efficiency way.

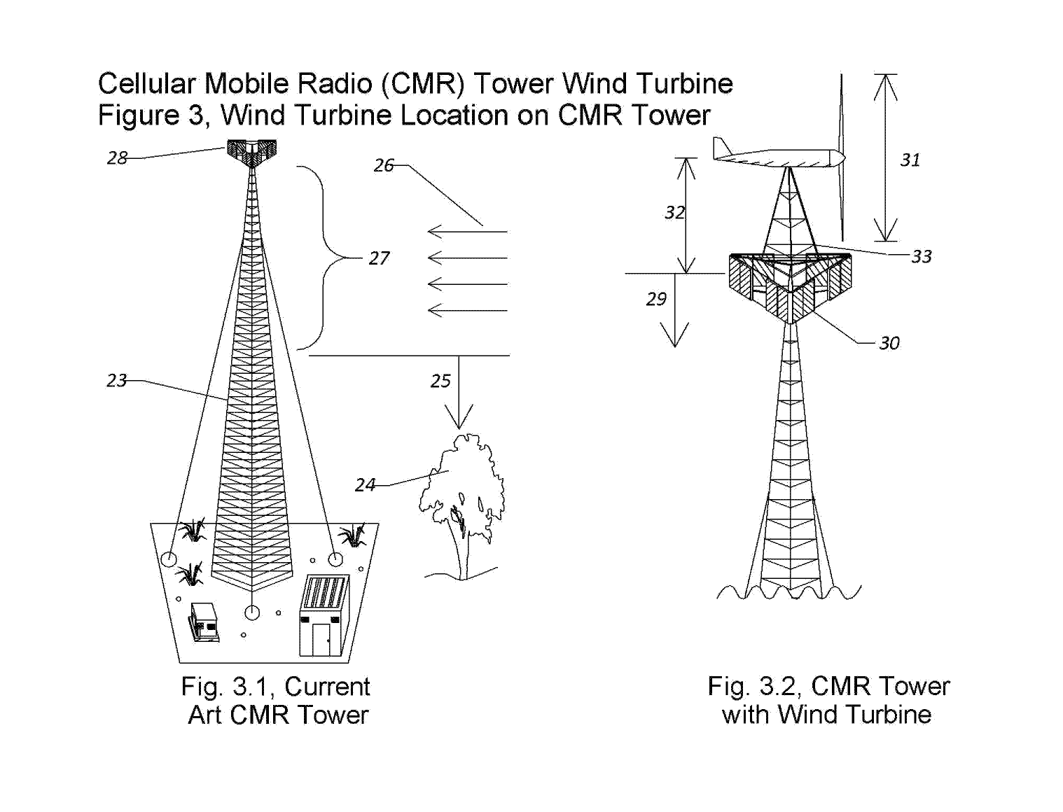

Reference FIG. 3.1, the wind turbine would be mounted on the CMRT tower structure (23) at a sufficient height above nearby obstacles (24) to avoid ground turbulence. Ordinarily, this height (25) would be at least 25 feet above surrounding obstacles (24). If the prevailing wind direction (26) remains consistent over time and if the structure permits, then the wind turbine may be mounted to the side of the tower (27). The reader versed in wind turbine configurations will recognize that this range of mounting heights may be especially useful for vertical axis wind turbines. As described in Claim Three, placing the wind turbine atop the tower (28) would allow for free movement with any wind direction (26). The wind turbine may be part of the initial design of the tower, or it may be an addition to the existing tower.

Referring to FIGS. 1.1 and 3.1, the reader informed in the arts of wind turbines will note that the class of wind turbine (2 kW to 50 kW) generally results in a blade diameter which is small enough to rest comfortably in various locations on the tower (27, 28) without interfering with the CMRT antenna operating angles (10). The informed reader will also note that the current art of small wind turbine employment typically involves mounting the turbine 30 and 70 feet above ground level; thus mounting it on the upper portions of a CMRT tower will offer the opportunity to generate power from the higher level (higher velocity) winds.

The reader informed in the arts of structural engineering will note that this installation requires design trade-offs. A more robust tower will often be required to accommodate the turbine, or the tower's load may be reduced by installing fewer transmission antennas. However, the invention creates overall synergistic advantages because the strengthening of an existing or newly planned CMRT tower is less expensive than the erection of a new tower dedicated to mounting a wind turbine. Likewise, the relatively small class of wind turbine which is needed for CMRT station power is of sufficiently light weight that many existing CMRT towers already have capacity to accommodate this additional mass.

The reader informed in the arts of electrical engineering will note that the location of the turbine in close proximity to the antennas allows for substantially shortened and simplified cable runs. These shortened cable runs enable significant reductions in power loss. This fact, coupled with the generation of the power by wind, substantially reduces the environmental impact of CMRT stations.

The reader informed in environmental matters will note that the location of these turbines on the tower enhances environmental quality in three ways. This method harvests available wind power around the tower. This method achieves the energy savings goals of the distributed power art through reduction of transmission losses and transformation losses. This method also minimizes the land needed to be developed to accommodate the CMRT tower and its power source.

Thus, this claim creates substantial synergistic advantages over the current separate arts described previously.

### Specification, Second Claim, a Method for Mounting a Wind Turbine on a CMRT Tower:

The second claim focuses specifically on the preferred embodiment of the invention. The preferred embodiment of the CMRTTWT is to mount the wind turbine on top of the CMRT tower, above the antennas. It is considered the preferred embodiment of the use of a wind turbine on a CMRT Tower because this embodiment accommodates the widest change in wind directions.

This preferred embodiment uses a windmill with blades which rotate about its horizontal axis. This horizontal axis wind turbine is the most commonly produced model of wind turbine. Likewise, the blade diameter of the horizontal axis wind turbine best illustrates the additional support and height which are essential to mounting a wind turbine on top of a CMRT tower.

The specifically preferred embodiment described in this second claim is the retrofitting of an existing CMRT tower with a height extension structure to mount a horizontal axis wind turbine. This specific embodiment is preferred due to the numerous existing CMRT towers and the opportunity to add wind turbines to those towers for immediate power generation with low environmental impact.

Referring to FIG. 3.2, the design of the preferred embodiment begins with a specified CMRT antenna height (29) on an existing tower with an existing arrangement of antennas and supports (30).

The design of this embodiment of the invention then selects the size of horizontal axis wind turbine desired for the site. The power available from a wind turbine is highly related to the diameter of the turbine blades (31). Those versed in the art of wind power generation will recognize that the selected turbine size is dependent upon situation-unique factors such as cost, weight, and desired power output. Design trades must be made to optimize overall lifecycle cost, typically including iteration between this step and the structural mounting design step in order to optimize overall lifecycle cost.

Once a size of horizontal wind turbine is specified, this defines a requirement for vertical separation between the antennas and the center of the axis of rotation of the horizontal axis wind turbine (32). This vertical separation is at least 50% of the diameter (31) of the wind turbine blade rotation.

The designer then selects a configuration for a mounting truss which is appropriate to the site-specific factors, including: the intended mounting height, the configuration of the wind turbine, and the existing configuration of the antenna mounting structure. A pyramidal shaped lattice truss structure (33) is the preferred embodiment for the mounting a horizontal axis wind turbine to most existing CMRT towers.

The reader versed in the arts of structural engineering will notice that this design embodiment will often require additional structural strengthening of the tower. When retrofitting the towers, the existing tower must be evaluated for its ability to accommodate the additional load of the wind turbine, and weak points must be identified. The strengthening of existing towers may include the addition of vertical supports to prevent the tower from crippling, the addition of new guy wires to accommodate the bending moment caused by drag on the turbine, strengthening of the upper portion of the tower to accommodate the extension, or a combination of any of these or other strengthening methods.

Those versed in the arts of CMRT site design, wind turbine specification, and structural engineering will note numerous variations to this preferred embodiment which may be made while still retaining the characteristics of the claim. Four of the most obvious variations include: the design of the retrofit structure; the use of a new tower in lieu of a retrofit; the use of a vertical axis wind turbine in lieu of a horizontal axis wind turbine; and the type of tower used for the design. Likewise, the reader versed in the related arts will note that this claim is flexible and may be adapted to the unique conditions of any CMRT tower site, conditions such as: the availability of construction equipment to the site, the cost of electricity from the power grid, the amount of service which is desired during outages of the power grid.

The exact design for the retrofit mounting structure is not limited to the preferred embodiment shown here. The reader informed in the arts described will readily recognize that the design process described by this claim may also find other optimal structural configurations which would be more suited to other existing conditions and other selections of a wind turbine. For instance, a monolithic tubular structure may be more appropriate for attaching to the top of a similarly designed round (tubular) tower.

The reader informed in the related arts of tower design will quickly recognize that the mounting of a wind turbine on a CMRT tower may be part of a newly designed application. When this claim is used in a new tower's design, the design would ordinarily begin by specifying an antenna height, the number of antennas, and the power of transmission. The designer would then specify the wind turbine as described above, performing design trades between the wind turbine and the other elements of the system. Finally, the designer would specify the new tower's configuration, being certain that that it possesses sufficient mounting structures and overall height to place the wind turbine sufficiently above the antennas and to place the antennas at their needed height.

Those informed in the arts of wind turbine design will recognize that vertical axis wind turbines are designed for confined space applications such as the one presented by the CMRT Tower Wind Turbine. While the horizontal axis wind turbine is the preferred embodiment presented here, a vertical axis wind turbine may similarly be used within the scope of this claim.

Likewise, it was noted in the summary of the current state of the art that the guyed lattice-type tower is only one possible structure which may be used as a CMRT tower. Those versed in the art of tower design will readily recognize that the use of other tower configurations still meets the intent of this claim if the resulting configuration of the tower accommodates CMRT antennas and a wind turbine above those antennas, and if the wind turbine is specifically designed to provide most or all of the power to the associated CMRT site transmission/reception electronics.

### Specification, Third Claim, Power-Regulated CMRT Tower Proportional Transceiver/Amplifier Availability:

The third claim is an integral element of the holistic practicality of the invention. This third claim enables continuous operation of the CMRT station with a wind turbine when other power is not available and the windmill is unable to provide full power to all of the CMRT station. This claim specifically integrates with the other elements of the invention to enable the utility of the invention during and immediately after disasters (both natural and man-made). A power-regulated CMRT station proportional transceiver/amplifier availability system (PTAAS) is specified which would provide electrical power to only those transceiver/amplifier combinations for which enough power is available. The PTAAS element of the preferred embodiment is described here.

The reader informed in the art of windmill designs readily recognizes that even in optimal locations, wind speed varies by an order of magnitude over time. This large variation in the wind speed creates a substantial variation in the power generated by a windmill. Ordinarily, this is a substantial disadvantage and requires the use of a second power source to accommodate periods when the windmill generates low power. In the preferred embodiment of this invention, the power grid is the second power source for the overall CMRTTWT system.

The reader informed in the art of electrical engineering also readily knows that the other option for accommodating variations in electrical supply is demand planning. In this context, demand planning is the restriction of demand when the available power is low. From a demand planning perspective, CMRT systems may be designed as a number of discrete transceiver/amplifier combinations. Each discrete transceiver/amplifier combination is designed to accommodate a certain maximum number of customers. This claim considers these discrete transceivers/amplifiers as discrete loads.

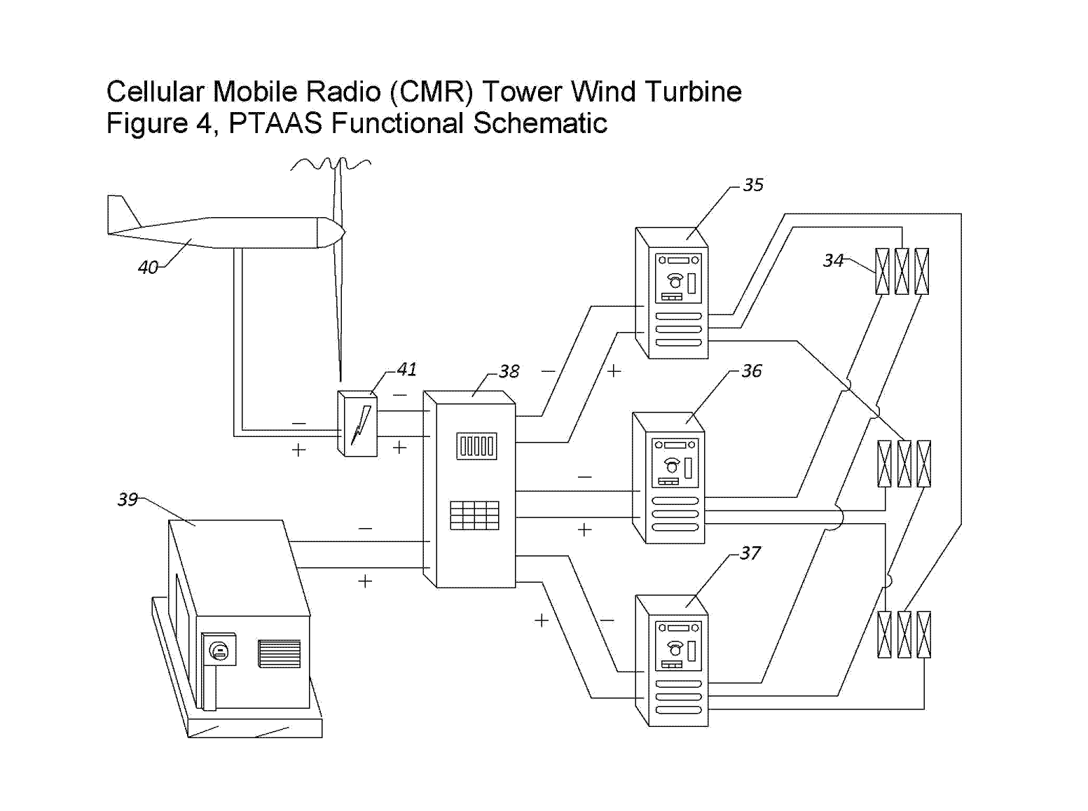

Referencing FIG. 4, a CMRT station typically services each of three directions, each comprising (approximately) a 120 degree portion of the 360 degrees around the tower, and each 120 degree portion serviced with a series of antennas (34). To segregate these as discrete loads, this claim uses a number of parallel transceiver/amplifier combinations (35, 36, 37), each operating through three antennas, each antenna providing a 120 degree portion of coverage. The three antennas for each transceiver/amplifier combination therefore combine to cover all of the three zones around the CMRT tower, and they each provide a portion of the complete network capability for the tower. This grouping of combinations of transceivers/amplifiers and antennas is not unique to this claim; however, this segregation forms the underlying configuration which is uniquely used by this claim for continuous CMRT station operations.

This claim considers that availability of a portion of these discrete transceivers/amplifiers is preferable to non-availability of the overall system, if the portion of these discrete transceiver/amplifier loads provides 360 degree coverage. Likewise, this claim considers that disasters which inhibit the power grid's availability are relatively rare, and that therefore proportional availability is preferable to the cost of designing a system for extreme conditions rarely experienced in practice. Thus, the PTAAS selectively powers part of the CMRT tower system when the primary power source provides too little power for the entire system, and when there is no second power source available.

In the preferred embodiment of this of this element of the CMRTTWT invention, the PTAAS includes an automatic selection of a portion of the transceiver/amplifier elements which would be operated with the limited power. Referencing FIG. 4, this automatic selection would be performed by an automatic switch box (38), typically the same switchbox which would control the overall distribution of power when the power grid is also available. In normal operation power is available from two sources: the power grid after conversion through the on-site transformer (39), and the wind turbine (40) coupled with the power conditioner (41). When the power grid is not available, power is only available from the wind turbine (40).

The automatic switchbox (38) works similarly in both conditions. During normal operation, the automatic switchbox (38) would provide power to discrete transceiver/amplifier combinations (35, 36, 37) with the available wind-generated power and would power the remaining transceiver/amplifier combinations (35, 36, 37) with electricity from the transformer (39) connected to the power grid. In emergency operation when electricity from the power grid is not available, the automatic switchbox (38) would operate the same way except that the switchbox would only provide power to those transceiver/amplifier combinations (35, 36, 37) for which the wind turbine (40) is generating sufficient power. Those familiar with the art of electrical engineering recognize that there are many methods to design a box as specified in this embodiment.

The reader informed in the art of electrical engineering will easily envision how this PTAAS system can be slightly modified to accommodate minor variations of the power source arrangement. Referencing FIG. 2 as an example, a small backup battery (22) could be used to provide additional power for a few minutes to a few hours to a few channels. The reader who understands the arts of electronic controls and transceiver/amplifier design will readily recognize that additions of batteries or other power sources to the preferred embodiment here remain within the overall scope of this claim.

### SUMMARY OF THE INVENTION AND ITS CLAIMS

The three claims of the CMRTTWT synergistically harvest available wind power to reduce the environmental impact of CMRT stations while making those stations available during and immediately following disasters (natural or man-made). The invention concerns the use of a wind turbine in conjunction with a CMRT Station to power the transmitters and receivers which comprise the primary function of that station. The first claim is the mounting of a wind turbine on a CMRT Tower, specifically sized to provide local power generation for that CMRT Station without interfering with the operations of that tower. The second claim is the preferred method of incorporating a windmill on a CMRT tower, which is on the top of the tower. The third claim involves a version of distributed power generation in which the CMRT tower's transmission/receiving services are regulated to match the power available by the wind turbine. This description of the CMRTTWT invention clearly shows it to be a unique improvement to the state of the art in Cellular Mobile Radiotelephone station design, that it is a unique combination of current art technologies, and that it uniquely creates a joint optimization of these currently separate technologies to provide reduced power grid consumption and increased availability of the CMRT network.

### OWNERSHIP OF INVENTION

I, Albert F. Lowas, III, certify that I conceived this invention without any knowledge of any other system which in any way resembles this invention, that I solely and individually formulated this complete invention, that I solely and individually developed the methodology and characteristics of this invention, and that I developed this patent application package wholly and completely on my personal effort and resources. No other entity with which I am associated was used in the development of this idea or the patent application related to this idea. Thus, I claim this invention (and its four claims) as a new and unique technology; furthermore, I claim sole ownership of this invention.

Signed:

Albert F. Lowas, III

31 Jan. 2011

This invention consists of three claims which together harvest available wind power in a way which synergistically improves the transmission/receiving tower/station infrastructure which is critical to the Cellular Mobile Radiotelephone industry:

1. An apparatus for mounting a wind turbine on a Cellular Mobile Radiotelephone station's antenna tower, said apparatus designed to: position the wind turbine in such a way as to receive sufficient wind energy so that said wind turbine provides the intended power to the Cellular Mobile Radiotelephone station; provide rotation for the wind turbine in applications where wind direction is not constant; and prevent the wind turbine from interfering with the wireless communications operations of the Cellular Mobile Radiotelephone station.

2. An apparatus for mounting a wind turbine on top of a Cellular Mobile Radiotelephone station's antenna tower, said apparatus designed to: position the wind turbine above the structure of the tower so that the wind turbine may align to any horizontal wind direction; maintain a desired separation between the wind turbine blades and the Cellular Mobile Radiotelephone antennas; and transfer the wind turbine's horizontal and vertical loads to the overall structure of the Cellular Mobile Radiotelephone tower.

3. An arrangement for a Cellular Mobile Radiotelephone station to optimally use the available power from a wind turbine, said arrangement designed to: provide electrical power to all functions of the Cellular Mobile Radiotelephone station when sufficient electrical power is available from the wind turbine; provide electrical power to all functions of the Cellular Mobile Radiotelephone station using a combination of the wind turbine electrical power and a secondary source of electrical power; and switch on or off portions of the operation of the Cellular Mobile Radiotelephone station based upon the available electrical power from the wind turbine.
